(19) United States
(12) Patent Application Publication
(10) Pub. No.: US 2016/0297438 A1
(43) Pub. Date: Oct. 13, 2016

(54) ACTIVE CRUISE CONTROL SYSTEM IN VEHICLE AND METHOD THEREOF

(71) Applicant: MANDO CORPORATION, Pyeongtaek-si (KR)

(72) Inventor: Kwangjin HAN, Seongnam-si (KR)

(21) Appl. No.: 15/093,465

(22) Filed: Apr. 7, 2016

(30) Foreign Application Priority Data
Apr. 13, 2015 (KR) 10-2015-0051818

(51) Int. Cl. B60W 30/16; B62D 15/02; G01S 19/42; G01C 21/34

(52) U.S. Cl. CPC B60W 30/16; G01C 21/34; B62D 15/0255; G01S 19/42

(57) ABSTRACT

Disclosed here are an active cruise control system in vehicle and method thereof. The active cruise control system in a vehicle includes: a vehicle sensing portion which measures driving speed, acceleration and a steering angle of the vehicle; a preceding vehicle sensing portion which senses a preceding vehicle which is driving in front of the vehicle; and a controller which performs lateral control based on the driving speed, the acceleration and the steering angle which have been measured and performs acceleration and deceleration control to keep a predetermined distance from the preceding vehicle when the measured driving speed which is a preset critical value or less.

### CROSS-REFERENCE TO RELATED APPLICATION

This application claims the benefit of Korean Patent Application No. 2015-0051818, filed on Apr. 13, 2015 in the Korean Intellectual Property Office, the disclosure of which is incorporated herein by reference.

### BACKGROUND

1. Field

Embodiments of the present disclosure relate to an active cruise control system in a vehicle, and more particularly, to an active cruise control system in a vehicle that yields driving convenience and safety for a user by functionalities including maintaining a constant distance from a preceding vehicle based on detecting a preceding vehicle and on the state of the vehicle, keeping a safe distance in a lane in which the vehicle is being driven, etc. to make autonomous driving possible and a control method of the same.

2. Description of the Related Art

In general, a lane keep assistance system (LKAS) is a system to assist a vehicle to keep a lane by operating the steering wheel when a lane departure that a user does not intend occurs or is predicted due to drowsy driving. When the driver departs a lane without generating a lane change signal, the LKAS assists the user to keep the lane by first generating a warning sound and then applying a suitable torque for steering. That is, when a vehicle departs a lane, such a LKAS is a system which detects the departure and assists a driver to drive the vehicle in a target lane at a corresponding speed.

The LKAS senses vehicle information such as a steering angle and a yaw rate in a vehicle through a sensor and the like, predicts a vehicle movement using a control logic which controls the vehicle by considering a lane, a radius of curvature, a departure angle, a lateral displacement, and the like based on the input signal sensed by the LKAS, determines an intervention timing, and then correctively control a steering torque according to an amount received from the control logic. The corrective control of the steering torque is performed by a motor drive power steering (MDPS).

However, since such a LKAS activates a steering control only when lane departure is sensed during high speed driving and does not perform the steering control during normal or low speed driving in a lane, a need for a technology for enhancing convenience of a driver when the driver drives at low speed such as in a congested traffic has been raised.

In addition, when a driver sets a vehicle speed to a predetermined speed, an adaptive cruise control (ACC) system nowadays provides convenience to a driver by keeping a vehicle speed according to an outside road condition even when the driver does not step on a brake or an accelerator.

Furthermore, even a smart cruise control system capable of decelerating or accelerating while keeping a distance from a preceding vehicle by having a radar system in the vehicle has been developed recently.

Such an ACC system of the vehicle controls an acceleration control system, an engine control system, and a brake control system of a controlled vehicle using information including a distance between the controlled vehicle and the preceding vehicle, relative speeds therebetween, and an angle of the controlled vehicle with respect to a driving direction sensed by a front radar sensor, etc. as well as a preset longitudinal speed and an acceleration limit of the controlled vehicle.

However, since longitudinal and lateral controls of a vehicle are separately performed by using such LKAS and ACC systems, there is an increasing need for lane keeping assistance which is not performed during low speed driving.

### SUMMARY

Therefore, it is an aspect of the present disclosure to integrally automatically control steering, acceleration, deceleration, and stopping by combining all of a preceding vehicle sensing sensor, a conventional wheel speed sensor, yaw rate, a steering angle, lateral acceleration, and the like of a configuration in which a lane keep assistance system (LKAS) and an adaptive cruise control (ACC) system are individually operated.

Accordingly, the present disclosure provides driving convenience for a user by assisting driving in congested traffic areas.

Additional aspects of the disclosure will be set forth in part in the description which follows and, in part, will be obvious from the description, or may be learned by practice of the disclosure.

In accordance with one aspect of the present disclosure, an active cruise control system in a vehicle includes a vehicle sensing portion which measures driving speed, acceleration, and a steering angle of the vehicle, a preceding vehicle sensing portion which senses a preceding vehicle of the vehicle, and a controller which performs a lateral direction control based on the driving speed, the acceleration, and the steering angle of the vehicle which have been measured when the measured driving speed of the vehicle is a preset critical value or less, and performs an acceleration and deceleration control to keep a predetermined distance from the sensed preceding vehicle.

In addition, the controller may include a vehicle movement prediction portion which predicts a movement of the vehicle based on the driving speed, the acceleration, and the steering angle which have been measured; a preceding vehicle trajectory generator which generates a trajectory of the preceding vehicle based on the predicted movement information and position information of the preceding vehicle sensed by the preceding vehicle sensing portion; an acceleration and deceleration controller which performs a acceleration and deceleration control based on the generated trajectory information of the preceding vehicle; and a steering controller which performs a lateral direction control based on the predicted movement information and the generated trajectory information of the preceding vehicle.

In addition, the acceleration and deceleration controller may perform acceleration, deceleration, and stopping controls to keep a predetermined distance from the preceding vehicle based on the generated trajectory information of the preceding vehicle.

In addition, the vehicle sensing portion may include a global positioning system (GPS) receiver which receives position information of the vehicle.

In addition, the movement information predicted by the vehicle movement prediction portion may further include received position information of the vehicle.

In accordance with another aspect of the present disclosure, an active cruise control method of a vehicle includes measuring driving speed, acceleration, and a steering angle of the vehicle; sensing a preceding vehicle of the vehicle; predicting a movement of the vehicle based on the driving speed, the acceleration and the steering angle which were measured; generating trajectory of the preceding vehicle based on the predicted movement information and the sensed position information of the preceding vehicle; performing acceleration and deceleration controls based on the generated trajectory information of the preceding vehicle; and performing a lateral direction control and a steering control based on the predicted movement information and the generated trajectory information of the preceding vehicle.

In addition, when the driving speed of the vehicle is a preset critical value or less, the trajectory of the preceding vehicle may be generated based on the predicted movement information and the sensed position information of the preceding vehicle.

In addition, the performing of the acceleration and deceleration controls may perform acceleration, deceleration, and stopping controls to keep a predetermined distance from the preceding vehicle base on the generated trajectory information of the preceding vehicle.

In addition, the trajectory of the preceding vehicle may be generated by further including GPS position information of the vehicle.

In accordance with an aspect of the present invention, an active cruise control system includes: a vehicle sensing portion which measures driving speed, acceleration and a steering angle of the vehicle, a preceding vehicle sensing portion which senses a preceding vehicle which is driving in front of the vehicle, and a controller which performs lateral control based on the driving speed, the acceleration and the steering angle which have been measured and performs acceleration and deceleration control to keep a predetermined distance from the preceding vehicle when the measured driving speed which is a preset critical value or less.

The controller may comprises a vehicle movement prediction portion which predicts movement information of the vehicle based on the driving speed, the acceleration and the steering angle which have been measured, a preceding vehicle trajectory generator which generates trajectory of the preceding vehicle based on the predicted movement information of the vehicle and position information of the preceding vehicle sensed by the preceding vehicle sensing portion, a driving route generator which generates a driving route of the vehicle based on the generated trajectory of the preceding vehicle, an acceleration and deceleration controller which performs an acceleration and deceleration control based on the generated driving route of the vehicle, a steering controller which performs a lateral direction control based on the predicted movement information and the driving route of the vehicle.

The acceleration and deceleration controller may perform acceleration, deceleration and stopping controls to keep a predetermined distance from the preceding vehicle based on the generated driving route.

The vehicle sensing portion may further comprise, a global positioning system receiver which receives position information of the vehicle.

The movement information which is predicted in the vehicle movement prediction portion may further comprise the received position information of the vehicle.

In accordance with another aspect of the present invention, a method of controlling an active cruise control system includes: measuring driving speed, acceleration and a steering angle of a vehicle: sensing a preceding vehicle which is driving in front of the vehicle, predicting movement information of the vehicle based on the driving speed, the acceleration and the steering angle which have been measured, generating a trajectory of the preceding vehicle based on the predicted movement information of the vehicle and position information of the preceding vehicle, performing acceleration and deceleration controls based on the trajectory of the preceding vehicle, and controlling a lateral control and a steering control based on the predicted movement information and the generated trajectory information of the preceding vehicle.

When the driving speed of the vehicle is a preset critical value or less, the trajectory of the preceding vehicle may be generated based on the predicted movement information and the sensed position information of the preceding vehicle.

The performing of the acceleration and deceleration controls may comprise generating a driving route based on the generated trajectory information of the preceding vehicle to keep a predetermined distance from the preceding vehicle, and performing acceleration and deceleration controls according to the driving route.

In the performing of the acceleration and deceleration controls, the trajectory information may further comprise generating the trajectory of the preceding vehicle by further comprising global positioning system (GPS) information of the vehicle.

### BRIEF DESCRIPTION OF THE DRAWINGS

FIG. 1 is a block diagram illustrating an active cruise control system to an embodiment of the present invention.

FIG. 2 is a block diagram illustrating a vehicle sensing portion in an active cruise control system to an embodiment of the present invention

FIG. 3 is a block diagram illustrating a preceding vehicle sensing portion in an active cruise control system to an embodiment of the present invention

FIG. 4 is a block diagram illustrating a controller in an active cruise control system to an embodiment of the present invention

FIG. 5 is a flowchart illustrating an active cruise control method according to an embodiment of the present invention.

### DETAILED DESCRIPTION

Hereinafter, the present disclosure will be described in detail with reference to accompanying drawings. The following embodiments are provided to convey the scope of the present disclosure to those in the art.

However, the present disclosure is not limited to the embodiment provided in this specification and may be realized in different forms. In the drawings, portions which are not related to the description may be omitted for clarifying the present disclosure, and sizes of components may be exaggerated for convenience of description.

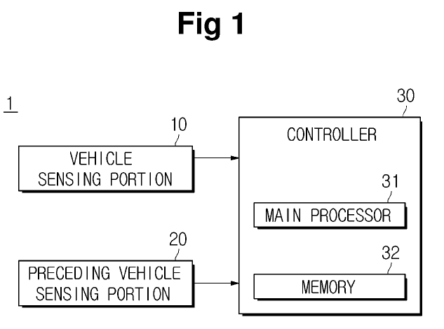

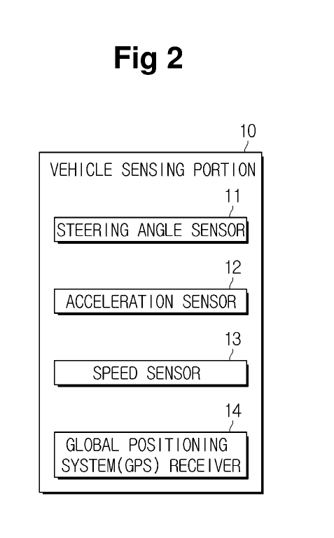

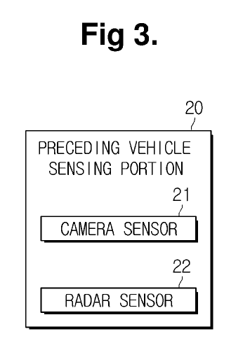

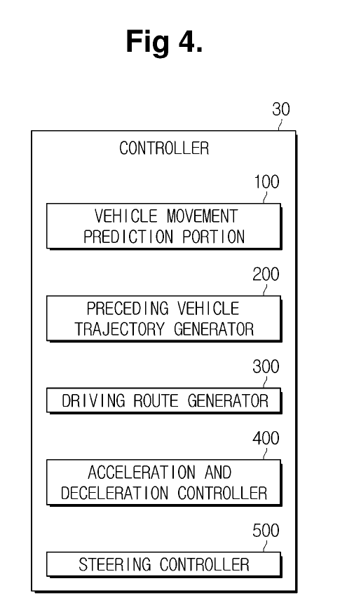

FIG. 1 is a block diagram of an active cruise control system 1 in a vehicle according to an embodiment of the present disclosure, FIGS. 2 to 4 are block diagrams of components of the active cruise control system 1 of the vehicle according to an embodiment of the present disclosure.

First, referring to FIG. 1, an active cruise control system 1 in a vehicle includes a vehicle sensing portion 10, a preceding vehicle sensing portion 20, and a controller 30.

The vehicle sensing portion 10 which is a component for sensing a status of the vehicle 1 senses speed, acceleration, steering, and the like of the vehicle and transmits the sensed information to the controller 30. Specifically, as illustrated in FIG. 2, the vehicle sensing portion 10 includes a steering angle sensor 11, an acceleration sensor 12, a speed sensor 13, and a global positioning system (GPS) receiver 14.

The steering angle sensor 11 measures a steering angle. The steering angle sensor 11 may be mounted at a lower end of a steering wheel 3 and may sense steering speed, a steering direction, and a steering angle of a steering wheel. Such a steering angle sensor 11 may include a steering wheel angular velocity sensor (not shown) which senses rotational speed of the steering wheel.

The acceleration sensor 12 measures acceleration of the vehicle. The acceleration sensor 12 may include a lateral acceleration sensor (not shown) and a longitudinal acceleration sensor (not shown). The lateral acceleration sensor measures acceleration along a lateral direction when X axis denotes the movement direction of the vehicle and a perpendicular axis of the movement direction (Y axis) is represented as the lateral direction. The longitudinal acceleration sensor may measure acceleration in the X axis of the movement direction of the vehicle.

Such an acceleration sensor in the acceleration sensor 12 is a component for sensing change in speed per unit time, senses dynamic forces such as acceleration, vibration, and shock and makes measurements using principals of an inertial force, electrostriction, and gyro. Next, the measured acceleration may be transmitted to the controller 30.

The speed sensor 13 may be installed inside of the wheel of the vehicle, sense rotational speed of the wheel of the vehicle and transmit the sensed signal to the controller 30. Specifically, the speed sensor 13 may include a wheel speed sensor (not shown) to measure speed of the vehicle.

The GPS receiver 14 receives a position of the vehicle 2. The GPS receiver 14 may receive the current position of the vehicle 2 and receive road information on which the vehicle 2 currently present from a database in a navigation unit which already has stored the road information. For example, the road information may include speed limit, lane information, and the like of the lane in which the vehicle is being driven. Such a GPS receiver 14 may transmit the received GPS information and other road information to the controller 30.

Next, the preceding vehicle sensing portion 20 in the active cruise control system 1 in the vehicle according to an embodiment of the present disclosure is a component for sensing a preceding vehicle 4 which is driving in front of the vehicle 2, and includes a camera sensor 21 and a radar sensor 22.

The camera sensor 21 may be provided with a camera sensor (not shown) to take a picture in the front direction of the vehicle 2, take a picture of the outside of the vehicle, and generate the image information.

The camera which is used generally includes one or more channels and normally includes a CMOS as the image sensor. The CMOS image sensor is a semiconductor device which converts an exposed image into electric data to transmit. Images obtained by the camera may be transmitted to the controller 30.

Accordingly, the obtained image by the camera may include images of the vehicle 2 and the preceding vehicle 4, and information on a lane in which the vehicle 2 and the preceding vehicle 4 are being driven.

In addition, the preceding vehicle sensing portion 20 includes a laser sensing portion 22. Such a laser sensing portion 22 may include a laser sensor to sense the preceding vehicle 4 which exists in front of the vehicle 2. An infrared light laser sensor generally used for such a laser sensor may emit infrared light toward the front of the vehicle and receive infrared light reflected by a vehicle in front thereof including the preceding vehicle 4.

In addition, the infrared light laser may provide an electric signal corresponding to infrared light to the controller 30, and the controller 30 may also calculate a distance between other vehicles and the vehicle using a magnitude of reflected infrared light or a time difference between emitted infrared light and reflected infrared light.

However, the preceding vehicle sensing portion 20 configured to sense the preceding vehicle 4 is not limited to a camera sensor or a laser sensor, and the preceding vehicle sensing portion 20 may also include a radar sensor (not shown) and the like to sense a preceding vehicle.

In addition, the preceding vehicle 40 which is sensed by the preceding vehicle sensing portion 20 may be a plurality of vehicles positioned in front of the vehicle 2 and does not mean only a preceding vehicle just in front of the vehicle 2.

The controller 30 generally controls the active cruise control system 1 in the vehicle according to an embodiment of the present disclosure.

Specifically, the controller 30 may mediate the data input/output between various components included in the active cruise control system 1 and the controller 30 of the vehicle 2 and include a main processor 31 which controls acceleration and deceleration and steering of the vehicle and a memory 32 which stores programs and data.

The memory 32 may temporarily memorize control data for controlling an operation of the active cruise control system 1 in the vehicle, vehicle information sensed by the vehicle sensing portion 10, preceding vehicle information sensed by the preceding vehicle sensing portion 20, various control signals output from the main processor 31, and the like.

Specifically, the memory 32 may include a volatile memory such as a S-RAM, and a D-RAM, as well as non-volatile memory such as a flash memory, a ROM, an erasable programmable read only memory (EPROM), and an electrically erasable programmable read only memory (EEPROM).

Particularly, the non-volatile memory may semi-permanently store a control program and control data for controlling the active cruise control system 1 in the vehicle, and the volatile memory may load the control program and the control data from the non-volatile memory and temporarily store the control program and the control data and temporarily store vehicle information sensed by the vehicle sensing portion 10, preceding vehicle information sensed by the preceding vehicle sensing portion 20, and various control signals output by the main processor 31.

In the above description, the structure of the controller 30 was described from a hardware perspective.

Hereinafter, such a controller 30 may include a vehicle movement prediction portion 100, a preceding vehicle trajectory generator 200, a driving route generator 300, an acceleration and deceleration controller 400, and a steering controller 500 from a software perspective.

First, the vehicle movement prediction portion 100 may calculate a movement distance and a direction of the vehicle 2 based on driving speed, acceleration, and steering angle of the vehicle sensed by the vehicle sensing portion 10 of the vehicle 2. That is, the vehicle movement prediction portion 100 may predict a relative movement distance of the vehicle and a direction of the vehicle using the steering angle, the vehicle speed, and the lateral acceleration which have been obtained.

Next, the preceding vehicle trajectory generator 200 generates a trajectory of a preceding vehicle based on position information of the preceding vehicle 4 obtained by the preceding vehicle sensing portion 20 of the vehicle 2, information on a lane in which the preceding vehicle 4 and the vehicle 2 are positioned, information on a distance between the vehicle 2 and the preceding vehicle 4 at present, and a relative movement distance and a direction of the vehicle predicted by the vehicle movement prediction portion 100.

In addition, the preceding vehicle 40 sensed by the preceding vehicle sensing portion 20 may include a plurality of front vehicles positioned in front of the vehicle 2 and does not mean only a preceding vehicle positioned just in front of the vehicle 2.

Accordingly, the preceding vehicle trajectory generator 200 may generate trajectories of the plurality of preceding vehicles positioned in front and generate the most suitable driving route for the vehicle 2 based on the generated trajectories of a plurality of front vehicles.

At this point, the driving route generator 300 generates a driving route of the vehicle 2 based on the trajectory of the preceding vehicle 4 generated. That is, the driving route generator 300 may generate a driving route using a continuous function of a polynomial type based on accumulated trajectory information of a preceding vehicle, however generation of a driving route is not limited thereto, and a driving route of the vehicle 2 may be generated by a known technology so that the error rate is minimized.

In addition, the driving route generator 300 may set a safe driving speed which keeps a safe distance from the preceding vehicle 4 based on a generated driving route.

Next, a longitudinal direction control of the vehicle 2 may be performed by an acceleration and deceleration controller 400 for performing active cruise according to an embodiment of the present disclosure based on the generated driving route of the vehicle, and a lateral direction control of the vehicle 2 may be performed using the steering controller 500.

Specifically, an acceleration and deceleration controller 400 controls acceleration, deceleration, and stopping so that the vehicle 2 keeps a safe driving speed to keep a predetermined distance from the preceding vehicle 4.

Particularly, the active cruise control system 1 in the vehicle according to an embodiment of the present disclosure performs active cruise for convenience of a driver when vehicle speed is a predetermined speed or less such as when driving in congested traffic areas and performs a longitudinal direction control to keep a safe distance from the preceding vehicle 4.

In addition, the active cruise control system 1 in the vehicle according to an embodiment of the present disclosure may also perform active cruise by calculating a trajectory according to trajectory of preceding vehicle for convenience of a user when driving in an area such as an intersection which has no lane.

The steering controller 500 may perform a lateral direction control based on information obtained through the vehicle sensing portion 10 and the preceding vehicle sensing portion 20 so that the vehicle does not depart a lane in which the vehicle is driving. Specifically, a lateral direction control according to an embodiment of the present disclosure may perform active cruise for convenience of a driver when vehicle speed is a predetermined speed or less such as when driving in congested traffic areas and perform a steering control so as not to depart a lane where driving even when a driver does not control the steering wheel.

In the above description, the structure of the active cruise control system 1 in the vehicle according to one embodiment was described.

Hereinafter, an operation of the active cruise control system 1 in the vehicle according to one embodiment will be described.

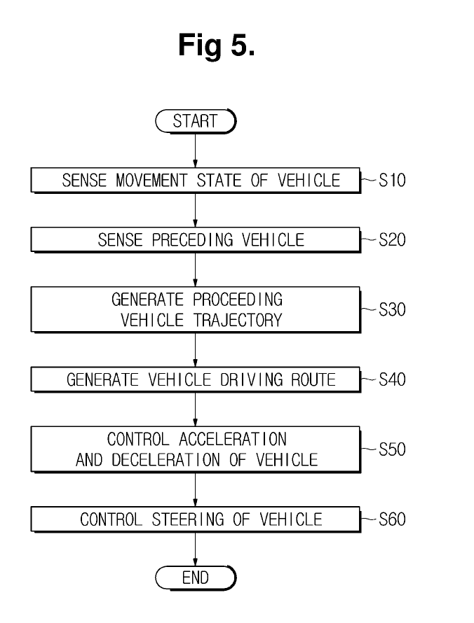

FIG. 5 is a flowchart of a control method of active cruise of a vehicle according to an embodiment of the present disclosure.

First, the vehicle 2 senses a movement state of the vehicle (S10). Specifically, the vehicle sensing portion 10 in the active cruise control system 1 in the vehicle obtains a steering angle, acceleration, vehicle speed and GPS information where the vehicle is currently positioned. Next, a relative movement distance and a direction of the vehicle may be predicted based on the obtained vehicle information.

In addition, the vehicle 2 senses a preceding vehicle (S20). Specifically, the preceding vehicle sensing portion 20 in the active cruise control system 1 in the vehicle obtains information on a distance between the preceding vehicle 4 and the vehicle 2 and information on a lane in which the vehicle is being driven. Next, the vehicle 2 generates a trajectory of the preceding vehicle based on information on the position of the preceding vehicle 4, information on the lane in which the preceding vehicle 4 and the vehicle 2 are positioned, information on a distance between the vehicle 2 and the preceding vehicle 4 at present, and information on a relative movement and a direction of the vehicle which are predicted by the vehicle movement prediction portion 100 (S30).

Next, a driving route of the vehicle 2 is generated based on the generated trajectory of the preceding vehicle (S40). Specifically, the controller 30 in the active cruise control system 1 in the vehicle may generate a driving route using a continuous function in a polynomial type based on accumulated trajectory information of the preceding vehicle.

At this point, safe driving speed which keeps a safe distance from the preceding vehicle 4 may be set based on the generated driving route.

Last, the controller 30 performs acceleration and deceleration controls of the vehicle according to the generated driving route of the vehicle (S50) and performs a steering control including a lateral direction control of the vehicle (S60). According to the active cruise control system 1 in the vehicle according to an embodiment of the present disclosure, convenience of a user is maximized when the driver drives in congested traffic areas, and acceleration, deceleration and stopping of the vehicle which are not conventionally performed may be performed while driving with a low speed.

As is apparent from the above description, embodiments of the present disclosure can integrally automatically control steering, acceleration, deceleration, and stopping by combining all of a preceding vehicle sensing sensor, a conventional wheel speed sensor, yaw rate, a steering angle, lateral acceleration, and the like of a configuration for which a lane keep assistance system (LKAS) and an adaptive cruise control (ACC) system are individually operated.

In addition, the embodiments of the present disclosure can provide driving convenience of a user by assisting driving in congested traffic areas accordingly.

While one embodiment of the present disclosure has been illustrated and described above with reference to the drawings, the present disclosure is not limited to the above-described specific embodiments, various modifications may be made by those skilled in the art without departing from the spirit and scope of the present disclosure described in the appended claims, and the modifications may not be individually understood from the present disclosure.

What is claimed is:

1. An active cruise control system in a vehicle, comprising:
a vehicle sensing portion which measures driving speed, acceleration and a steering angle of the vehicle;
a preceding vehicle sensing portion which senses a preceding vehicle which is driving in front of the vehicle; and
a controller which performs lateral control based on the driving speed, the acceleration and the steering angle which have been measured and performs acceleration and deceleration control to keep a predetermined distance from the preceding vehicle when the measured driving speed which is a preset critical value or less.

2. The system of claim 1, wherein the controller comprising:
a vehicle movement prediction portion which predicts movement information of the vehicle based on the driving speed, the acceleration and the steering angle which have been measured;
a preceding vehicle trajectory generator which generates trajectory of the preceding vehicle based on the predicted movement information of the vehicle and position information of the preceding vehicle sensed by the preceding vehicle sensing portion;
a driving route generator which generates a driving route of the vehicle based on the generated trajectory of the preceding vehicle;
an acceleration and deceleration controller which performs an acceleration and deceleration control based on the generated driving route of the vehicle;
a steering controller which performs a lateral direction control based on the predicted movement information and the driving route of the vehicle.

3. The system of claim 2, wherein the acceleration and deceleration controller performs acceleration, deceleration and stopping controls to keep a predetermined distance from the preceding vehicle based on the generated driving route.

4. The system of claim 3, wherein the vehicle sensing portion further comprises:
a global positioning system receiver which receives position information of the vehicle.

5. The system of claim 4, the movement information which is predicted in the vehicle movement prediction portion further comprises the received position information of the vehicle.

6. An active cruise control method of a vehicle, comprising:
measuring driving speed, acceleration and a steering angle of a vehicle;
sensing a preceding vehicle which is driving in front of the vehicle;
predicting movement information of the vehicle based on the driving speed, the acceleration and the steering angle which have been measured;
generating a trajectory of the preceding vehicle based on the predicted movement information of the vehicle and position information of the preceding vehicle;
performing acceleration and deceleration controls based on the trajectory of the preceding vehicle; and
controlling a lateral control and a steering control based on the predicted movement information and the generated trajectory information of the preceding vehicle;

7. The method of claim 6, wherein when the driving speed of the vehicle is a preset critical value or less, the trajectory of the preceding vehicle is generated based on the predicted movement information and the sensed position information of the preceding vehicle

8. The method of claim 7, wherein the performing of the acceleration and deceleration controls comprises generating a driving route based on the generated trajectory information of the preceding vehicle to keep a predetermined distance from the preceding vehicle, and performing acceleration and deceleration controls according to the driving route.

9. The method of claim 8, further comprising generating the trajectory of the preceding vehicle by further comprising global positioning system (GPS) information of the vehicle.
